(19) United States
(12) Patent Application Publication
(10) Pub. No.: US 2013/0104187 A1
(43) Pub. Date: Apr. 25, 2013

(54) CONTEXT-DEPENDENT AUTHENTICATION

(71) Applicant: Klaus Helmut Weidner, Kirkland, WA (US)

(72) Inventor: Klaus Helmut Weidner, Kirkland, WA (US)

(21) Appl. No.: 13/655,033

(22) Filed: Oct. 18, 2012

Related U.S. Application Data
(60) Provisional application No. 61/548,618, filed on Oct. 18, 2011.

(51) Int. Cl. G06F 21/45

(52) U.S. Cl. CPC G06F 21/45
USPC 726/1

(57) ABSTRACT

An electronic device is secured by determining, by a processor, that an electronic device is in a first secured state associated with a first security level. Based on the first security level, a first context-dependent authentication policy is assigned to the electronic device. A transition rule is determined to have been satisfied, and responsively the electronic device transitions into a second secured state, wherein the second secured state comprises a different security level than the first secured state. The first context-dependent authentication policy is modified to yield a second context-dependent authentication policy, and the device is changed from the second secured state upon the device receiving an authentication that satisfies the second context-dependent authentication policy.

### RELATED APPLICATIONS AND CLAIM OF PRIORITY

This patent application claims priority to U.S. Provisional Patent Application No. 61/548,618, filed Oct. 18, 2011, entitled “Adaptive User Authentication with Context-Dependent Security Levels,” the disclosure of which is entirely incorporated herein by reference.

### BACKGROUND

Portable electronic devices, such as smart phones, personal digital assistants, laptop computers, tablet computing devices, media players and the like typically employ security settings that enable the device to be locked until a user is authenticated to the device, and that enter a locked state automatically after a period of inactivity. There are many user authentication methods available to unlock such a locked device, with varying levels of user convenience and security. Examples include passwords, Personal Identification Numbers (PINs), facial recognition, or fingerprint scanners. Typically, users (or administrators) enable one or more authentication methods, and users can then use any of these enabled methods to authenticate. If an authentication method such as facial recognition is considered insufficiently secure, it is disabled and unconditionally unavailable for authentication.

### BRIEF DESCRIPTION OF THE DRAWINGS

FIG. 1 depicts an example of an electronic device that may perform an authentication process.

FIG. 2 is a flowchart that shows how a device may determine an authentication policy and verify a user authentication.

FIG. 3 is a flow diagram illustrating how an electronic device may transition between various examples of security states.

FIG. 4 is a block diagram illustrating an example of a mobile device that may provide context-dependent authentication.

### SUMMARY

In one example embodiment, a method of securing an electronic device comprises determining, by a processor, a first security state from a plurality of security states of an electronic device, the plurality of security states comprising a plurality of secured states and an insecure state. The device changes to a second secured security state of the plurality of security states responsive to determining that a transition rule has been satisfied, the changing to a second secured security state defined by the transition rule. Based on the change to the second secured security state, the device assigns a context-dependent authentication policy associated with the second secured security state to the electronic device. The device changes from the second secured security state upon the device receiving an authentication that satisfies the current context-dependent authentication policy.

In another example, a method of securing an electronic device comprises determining, by a processor, that an electronic device is in a first secured state associated with a first security level. Based on the first security level, the device assigns a first context-dependent authentication policy to the electronic device. The device determines that a transition rule has been satisfied; and responsive to determining that the transition rule has been satisfied, causes the electronic device to transition into a second secured state, wherein the second secured state comprises a different security level than the first secured state. The device modifies the first context-dependent authentication policy to yield a second context-dependent authentication policy, and changes from the second secured state upon the device receiving an authentication that satisfies the second context-dependent authentication policy.

### DETAILED DESCRIPTION

This disclosure is not limited to the particular systems, devices and methods described, as these may vary. The terminology used in the description is for the purpose of describing the particular versions or embodiments only, and does not limit the scope of the claims.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.” As used in this document, the terms “sum,” “product” and similar mathematical terms are construed broadly to include any method or algorithm in which a datum is derived or calculated from a plurality of input data.

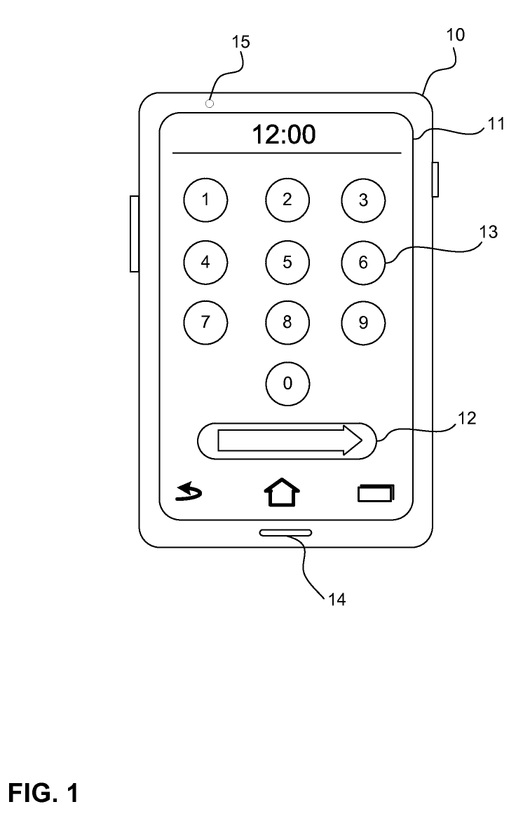

For the purposes of this document, an “electronic device” refers to a device that includes a processor and tangible, computer-readable memory. Memory includes various tangible storage media, including flash or nonvolatile memory, random access memory (RAM), optical or magnetic storage media, and other such data storage devices. The memory may contain programming instructions that, when executed by the processor, cause the device to perform one or more operations according to programming instructions. Examples of electronic devices include portable electronic devices such as smartphones, personal digital assistants, cameras, tablet computers, laptop computers, media players and the like. An example of a portable electronic device 10 is shown in FIG. 1. The description contained below uses a smartphone as an example electronic device, but the methods described below can also apply to any electronic device requiring authentication, such as a laptop, a desktop computer, or even an electronic door lock.

Many electronic devices are configured to automatically enter a secured, or locked, state when not in use for specific amounts of time. The user may then be required to enter an authentication in order to transition the device from the secured state (in which the user cannot use the device) to an insecure state (in which the user may use the device and access the device's functions). Examples of authentications include security codes, facial recognition methods, voice recognition patterns, and other now or hereafter known authentication technologies. For example, the device may include a display such as a touch screen with a touch-sensitive field 12 on which the user must swipe or place his or her finger. The authentication required by the touch-sensitive field may simply be a swipe of the finger, or it may be a biometric recognition technology such as a fingerprint reader. The display or a keypad of the device may accept an authentication code 13 such as personal identification number (PIN) or passcode. An audio input 14 such as a microphone may accept an authentication such as by a voice-entered passcode or PIN. An image sensor 15 such as a camera may capture an image of the user so that the device can perform facial recognition. Any or all of these authentication methods will be implemented by programming instructions that are stored in a memory and used by the processor of the electronic device, or by a processor of a remote server that is in electronic communication with the electronic device via a wireless or wired communication network.

The amount of time required before a device moves from a secured state to an insecure state may vary by device. Users of electronic devices generally do not like very short lock timeouts, because the user must to re-enter his or her password or other authentication very frequently. On the other hand, if the device has a longer timeout before moving from an insecure to a secured state, the device will be unprotected during this time.

If electronic devices support use of a more convenient authentication method, such as facial recognition, users may be more willing to tolerate a substantially shorter lock timeout. However, a problem with prior lockout approaches is that they lack context awareness. A lower-security authentication method may be acceptable in some circumstances, for example if the device was just locked a short time ago, and can be far more convenient for users, even if it is not considered sufficiently secure as a general-use authentication method.

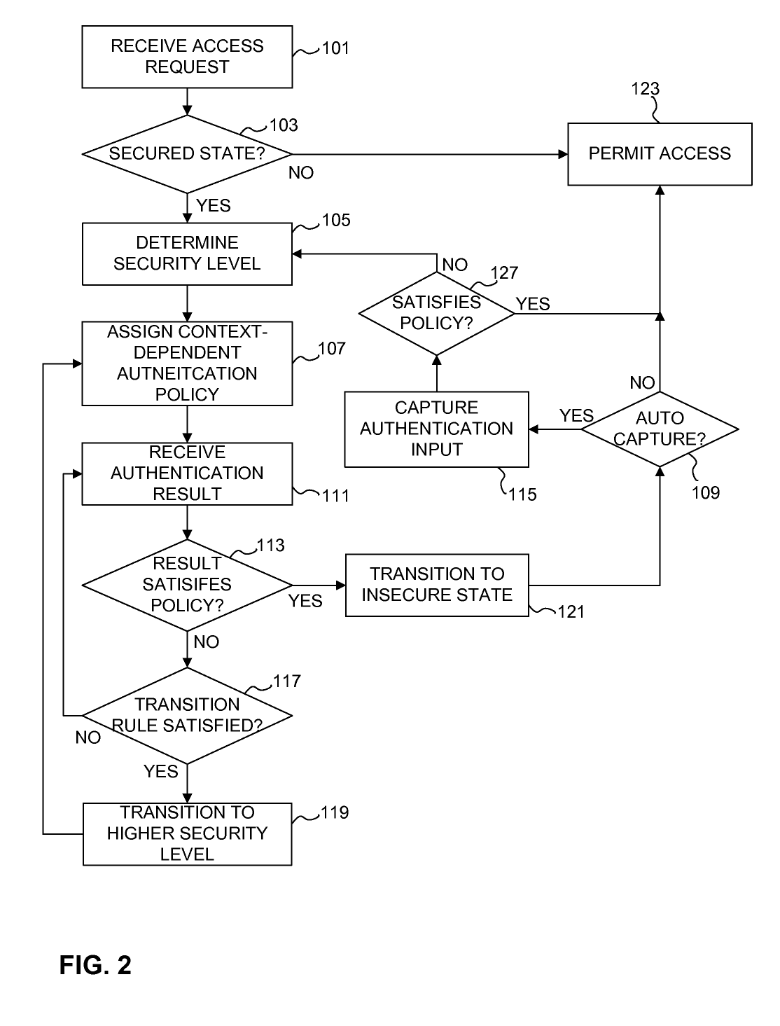

FIG. 2 illustrates a process by which authentication policies may be assigned to an electronic device, and by which authentications may be validated, in accordance with various embodiments. Referring to FIG. 2, an electronic device may receive an access request 101. The access request may be any input, such as an indication that the power button or one or more keys have been depressed, a touch screen input, a biometric identifier, or another request or command to access the device. In response to receiving the access request, or simply as part of normal operation of the device on a periodic basis, a security application may cause the device to determine whether it is in such a secured state 103 in which authentication is required before a user can use one or more features of the device. If the device is not in such a secured state, then the user may be permitted access 123 to the device and use of one or more of the device's features. If the device is in a secure state, then the security application may determine a security level or security state for the electronic device from a set of candidate security levels 105. For example, candidate security levels may include grades or ranks of security such as “low/medium/high” or “1/2/3.” Any number of candidate security levels may be available.

Security states in some examples such as this include an insecure state, and two or more secured states, where each of the two or more secured states is associated with a different context and authentication policy. Based on the device's security state, the security application will assign a context-dependent authentication policy to the electronic device 107. The context-dependent authentication policy will be one that varies based on one or more parameters relating to use of the device. Examples of such parameters will be described below. The device will be retained in the secured state until the device receives an authentication result 111 that satisfies the context-dependent authentication policy.

When the electronic device receives an authentication that satisfies the context-dependent authentication policy 113, it may transition into an insecure state so that a user may access 123 one or more of the device's features. If the authentication does not satisfy the policy, or if another action has happened such as the passage of a threshold period of time, then the security application may determine whether a transition rule has been satisfied 117. The transition rule may be, for example, the occurrence of a certain number of failed authentication attempts, the passage of a threshold period of time without device use, a determination that the device has moved more than a certain distance from a reference location, or another rule. If the transition rule has been satisfied, the device may be transitioned to a higher secured state or security level 119. A higher secured state will require an authentication process that is generally more secure than a lower secured state. For example, a lower secured state may permit unlocking with either facial recognition or PIN or password at the user's choice, while a higher secured state may require entry of the user's PIN or password, or a combination of two procedures such as facial recognition and PIN entry.

Note that the terminology “lower” or “higher” secured state in this example does not necessarily imply a strict hierarchy of acceptable authentication methods. More generally, the configuration in this example consists of a set of secured state policies where each policy defines a set of acceptable authentication methods. Some methods may be available at multiple secured states, but each policy can define its own combination independently.

In some further examples, when a device is in an insecure state, after the passage of a threshold period of time or the occurrence of a threshold event the device may perform an automatic re-authentication process 109. The re-authentication process will automatically capture an authentication 115, and the device will be retained in the insecure state only if a result of the authentication process satisfies an insecure state re-authentication confirmation policy 127. In some such examples, the re-authentication can happen at any time, and does not require going through a secure state before re-authentication.

As a more detailed example, consider an authentication policy set for a smartphone, where a user presses the smartphone's power button momentarily to turn off the screen and place the smartphone in a locked and secured security state:

| USER ACTION | AUTHENTICATION POLICY |
|---|---|
| Turn on within 5 minutes of locking | Device is available without any re-authentication |
| Turn on between 5 minutes and | Require level 1 authentication (facial recognition) |
| within 1 hour of locking | |
| Turn on between 5 hours and 3 days | Require level 2 authentication (PIN) |
| of locking | |
| Turn on after 3 days of locking | Require level 3 authentication (linked account password) |

A flexible security policy such at this may offer improved convenience for users, while providing security equivalent to or better than traditional policies. For example, assuming that users are unwilling to accept a lock timeout shorter than 10 minutes if they need to enter their password to authenticate, the use of facial recognition for authentication in the interval from 2-10 minutes could be employed, and even a relatively insecure facial recognition system would be an improvement over leaving the device completely unprotected in an insecure security state during this interval. After the 10 minute interval has passed, the system may require entry of a password or PIN. Also, if the system determines that the device is away from a location that is not known as trusted location, such as by comparing global positioning system data or a location derived from a network address to a set of trusted positions and addresses, the system may assume that the device is in a public place and require biometrics for unlocking the device, thus reducing opportunities for shoulder-surfing passwords, while still maintaining security for lost or stolen devices.

A typical configuration may define a hierarchy of security states with associated authentication methods, where lower security authentication methods may only be used in low security states, while the highest security methods can be used in all security states. In each of these cases, when the device has been assigned a security level, any form of authentication for that level or any higher level may be considered acceptable. For example, if the device is assigned to a low security level in which facial recognition is acceptable, the user could choose to enter a security pattern/PIN instead of using facial recognition. This would be useful, for example, if the phone is in a poorly-lit environment where the camera can't get a good picture.

More generally, the device may distinguish between multiple secured security states, and uses rules to switch between the security states. Each security state is associated with a set of authentication methods considered acceptable to unlock the device from that state. The rules to switch between security states are based on the information available to the device, including but not limited to time, sensor input, and data received from communication channels. The security application allows the device to distinguish between multiple secured modes or security levels with varying sets of acceptable authentication methods. Transitions between these security states may occur autonomously, not just in response to user input such as failed authentication attempts.

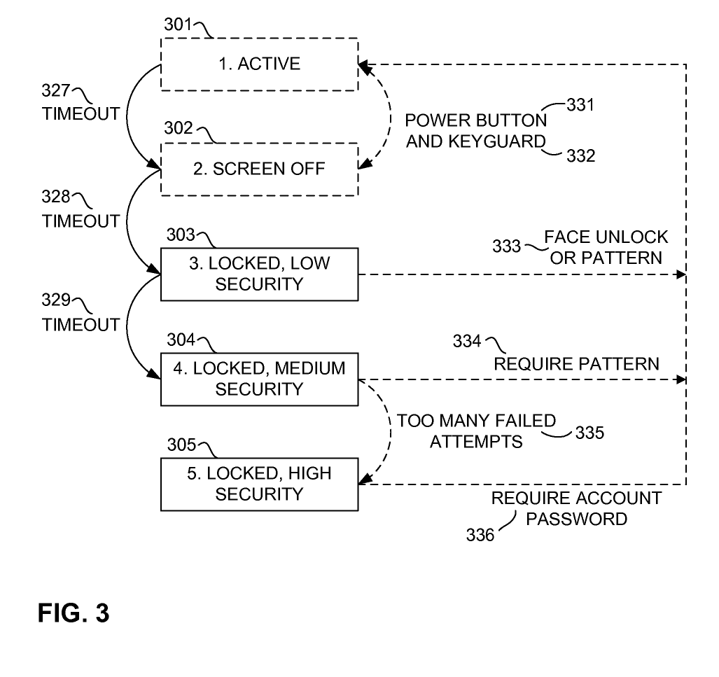

For example, as shown in FIG. 3, a set of security states may include (1) active and unlocked 301; (2) screen off, not locked 302; (3) locked in a low security secured state 303; (4) locked in medium or normal security secured state 304; and (5) locked in a high security secured state 305. In FIG. 3, modes that are associated with insecure security states are represented by boxes that are formed of dotted lines, while modes associated with secured security states are represented by boxes formed of solid lines. Transitions between security states may occur automatically (without external input) upon the satisfaction of certain state transition conditions. For example the passage of a threshold period of time 327-329 (represented by solid lines in FIG. 3) may automatically transition the device to the next higher security state. Alternatively, transitions between security states may occur after the system has received certain inputs (represented by dashed lines in FIG. 3), such as a power button activation 331; a keyguard action 332; facial recognition 333; a passcode, PIN or pattern 334; or a higher level password 336, each of which may allow the device to transition to an insecure security state. Inputs can also cause the device to transition from a lower security state to a higher security state. Such inputs may include, for example, the receipt of a threshold number of failed authentication attempts 335.

Corresponding accepted authentication methods for each security state shown in FIG. 3 may include, for example:

(1) active and unlocked 301: no authentication needed (user is currently considered authenticated);

(2) screen off 302: no authentication needed (user still considered authenticated); a keyguard action such as a “drag to unlock” gesture may be required to prevent accidental activation but is not considered an authentication method;

(3) locked, low security 303: accept any one of facial recognition, security pattern/PIN, or higher-level account password;

(4) locked, medium security 304: accept any one of security pattern/PIN, or higher-level account password; and

(5) locked, high security 305: require account password.

The state transitions may include:

(1) State 301, detect power button activation, transition to state 302.

(2) State 302, elapsed time 5 minutes, transition to state 303.

(3) State 302, detect power button activation, transition to state 301.

(4) State 303, elapsed time total 1 hour, transition to state 304.

(5) State 303, authenticate, transition to state 301.

(6) State 303, failed authentication, transition to state 304.

(7) State 304, elapsed time total 3 days, transition to state 305.

(8) State 305, authenticate, transition to state 301.

(9) State 304, failed authentication, transition to state 305.

(10) State 305, authenticate, transition to state 301.

The state transition rules can be based on different and/or more complex rules than those illustrated in FIG. 2, and may use any of the device's input channels such as sensors or network communication. Examples of transition rules may include:

Illumination Sensor Transition Rule:

The security application may use a light detection circuit to apply an illumination sensor policy that detects whether the device is in an illuminated environment (such as a lit room or outside) or a dark environment (such as a user's pocket, purse or backpack). If the device transitions to a locked state, then within a short threshold period of time (such as less than 5 minutes or less than one minute) the device transitions to a dark environment, then within a second short threshold period of time (such as less than 5 minutes or less than one minute) the device transitions to an illuminated environment, the device may transition to an insecure state.

Accelerometer and/or Gyroscope Transition Rules:

The security application may monitor measurements of an accelerometer or gyroscope that is integral with the device. If the device determines that the phone been motionless for a window of time (such as 5 minutes to one hour), it may delay transition to a higher security state by a delay period (such as 5 minutes to one hour) or apply a longer timeout period. The device may use accelerometer or gyroscope outputs or other transition parameters for other state transition decisions such as: (1) positional pattern recognition (i.e., whether the device is in a substantially horizontal position such that it is likely to be placed on a table, or in a fixed angle that corresponds to an angle of a docking position); (2) detection of distinctive movement patterns (i.e., the device is moving up, down and forward in a pattern that substantially matches a pattern that is known to be that of the user's carrying the device in his or her a pocket); and (3) characteristic user movement corresponding to activating the phone.

Location Transition Rule:

The security application may monitor the location of the device, based on GPS data or the network to which the device is in communication, and apply shorter timeouts when the device is not in a known or trusted place such as the user's workplace.

Associated Device Transition Rule:

The security application may monitor whether the device is using a near field communication (NFC) technology to determine whether the device has been in continuous proximity to another known device (such as a Bluetooth headset or car dock) for a threshold period of time. If so, the application may delay transition to a higher security level or apply a longer timeout period.

Recognized Sound Transition Rule:

The security application may monitor sounds using the device's microphone or other audio input. Based on the sounds, the device may increase or decrease the timeout periods. For example, if the device recognizes a familiar sound pattern (e.g., the sound of a car or other environment, or the user's voice), it may apply a longer timeout period. On the other hand, if the device recognizes a known adverse sound (such as someone yelling the phrase “stop thief”, or if it detects sounds that it cannot recognize (such as multiple unrecognized voices, which may indicate that the phone is in a public place), it may apply a shorter timeout period. Data for familiar sounds and known adverse sounds may be stored in memory and compared to the received sounds. Received sounds may be saved so that the device can determine whether to classify a sound as familiar. For example, if the device detects a particular sound pattern for more than a set number of times, or multiple times within a set time period, it may classify the sound as familiar.

Temperature Detection Transition Rule:

The security application may monitor output from a temperature sensor on the electronic device and use those results to determine whether to accelerate or decelerate state transitions. For example, if the device is consistently at a temperature that is near typical human body temperature, it may presume that the device is in a user's pocket and thus apply a longer timeout period. On the other hand, if the device is subject to multiple temperature changes within a time window (such as a one-hour time window), it may presume that the device being passed around in multiple locations and thus apply a shorter timeout period.

Command Transition Rule:

The security application also may transition the device to a different state if it receives a command via a communication signal to do so. For example a user may send a command through communication channels, such as the Internet or a wireless network, with a command indicating that the phone has been misplaced and should move to a higher security level.

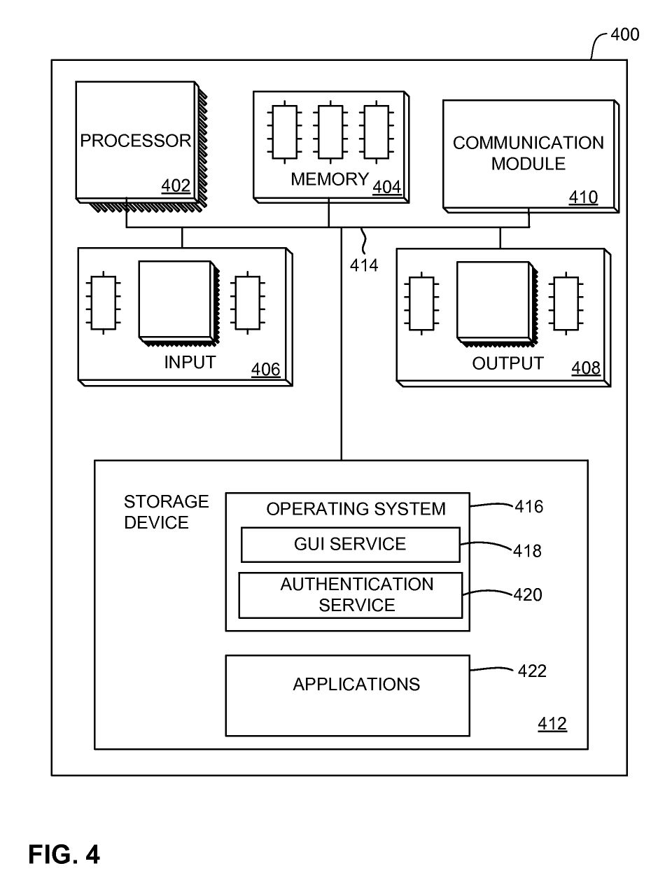

FIG. 4 shows a mobile device that provides context-dependent authentication, consistent with an example embodiment. FIG. 4 illustrates only one particular example of computing device 400, and many other examples of computing device 400 may be used in other examples.

As shown in the specific example of FIG. 4, computing device 400 includes one or more processors 402, memory 404, one or more input devices 406, one or more output devices 408, one or more communication modules 410, and one or more storage devices 412. Computing device 400, in one example, further includes an operating system 416 executable by computing device 400. The operating system includes in various examples services such as a graphical user interface service 418 and an authentication service 420. One or more applications 422 are also stored on storage device 412, and are executable by computing device 400. Each of components 402, 404, 406, 408, 410, and 412 may be interconnected (physically, communicatively, and/or operatively) for inter-component communications, such as via one or more communications channels 414. In some examples, communication channels 414 may include a system bus, network connection, interprocess communication data structure, or any other channel for communicating data. Applications such as 422 and operating system 416 may also communicate information with one another as well as with other components in computing device 400.

Processors 402, in one example, are configured to implement functionality and/or process instructions for execution within computing device 400. For example, processors 402 may be capable of processing instructions stored in storage device 412. Examples of processors 402 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 412 may be configured to store information within computing device 400 during operation. Storage device 412, in some examples, is described as a computer-readable storage medium. In some examples, storage device 412 is a temporary memory, meaning that a primary purpose of storage device 412 is not long-term storage. Storage device 412, in some examples, is described as a volatile memory, meaning that storage device 412 does not maintain stored contents when the computer is turned off. In other examples, data is loaded from storage device 412 into memory 404 during operation. Examples of volatile memories include random access memories (RAM), dynamic random access memories (DRAM), static random access memories (SRAM), and other forms of volatile memories known in the art. In some examples, storage device 412 is used to store program instructions for execution by processors 402. Storage device 412 and memory 404, in various examples, are used by software or applications running on computing device 400 (e.g., applications 422) to temporarily store information during program execution.

Storage devices 412, in some examples, also include one or more computer-readable storage media. Storage devices 412 may be configured to store larger amounts of information than volatile memory. Storage devices 412 may further be configured for long-term storage of information. In some examples, storage devices 412 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 400, in some examples, also includes one or more communication units 410. Computing device 400, in one example, utilizes communication unit 410 to communicate with external devices via one or more networks, such as one or more wireless networks. Communication unit 410 may be a network interface card, such as an Ethernet card, an optical transceiver, a radio frequency transceiver, or any other type of device that can send and/or receive information. Other examples of such network interfaces may include Bluetooth, 3G and WiFi radios computing devices as well as Universal Serial Bus (USB). In some examples, computing device 400 utilizes communication unit 410 to wirelessly communicate with an external device, or any other computing device.

Computing device 400, in one example, also includes one or more input devices 406. Input device 406, in some examples, is configured to receive input from a user through tactile, audio, or video feedback. Examples of input device 406 include a presence-sensitive touchscreen display, a mouse, a keyboard, a voice responsive system, video camera, microphone or any other type of device for detecting input from a user. In some examples, a presence-sensitive display includes a touch-sensitive screen commonly known as a touchscreen.

One or more output devices 408 may also be included in computing device 400. Output device 408, in some examples, is configured to provide output to a user using tactile, audio, or video stimuli. Output device 408, in one example, includes a presence-sensitive touchscreen display, a sound card, a video graphics adapter card, or any other type of device for converting a signal into an appropriate form understandable to humans or machines. Additional examples of output device 408 include a speaker, a light-emitting diode (LED) display, a liquid crystal display (LCD), or any other type of device that can generate output to a user. In some examples, input device 406 and/or output device 408 are used to provide operating system services, such as graphical user interface service 418, such as via a presence-sensitive touchscreen display.

Computing device 400 may include operating system 416. Operating system 416, in some examples, controls the operation of components of computing device 400, and provides an interface from various applications such as 422 to components of computing device 400. For example, operating system 16, in one example, facilitates the communication of application 422 with processors 402, communication unit 410, storage device 412, input device 406, and output device 408. Applications such as 422 may each include program instructions and/or data that are executable by computing device 400. As one example, application 422 or authentication service 420 may include instructions that cause computing device 400 to perform one or more of the operations and actions described in the present disclosure.

The methods described herein may be implemented, at least in part, in hardware, software, firmware, or any combination thereof. For example, the described methods may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the methods described herein.

Such hardware, software, and firmware may be implemented within the same device or within separate devices to support the various methods described herein. In addition, any of the described units, modules or components may be implemented together or separately as discrete but interoperable logic devices. Depiction of different features as modules or units is intended to highlight different functionality and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The methods described herein may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in memory or nonvolatile memory).

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of securing an electronic device, comprising:
determining, by a processor, a first security state from a plurality of security states of an electronic device, the plurality of security states comprising a plurality of secured states and an insecure state;
changing to a second secured security state of the plurality of security states responsive to determining that a transition rule has been satisfied, the changing to a second secured security state defined by the transition rule;
based on the change to the second secured security state, assigning a context-dependent authentication policy associated with the second secured security state to the electronic device; and
changing the device from the second secured security state upon the device receiving an authentication that satisfies the current context-dependent authentication policy.

2. The method of claim 1, wherein the transition rules used for changing between security states comprises one or more of:
determining a period of time that the device was in the first secured state, and comparing it to a threshold time interval; and
determining a number of failed authentication attempts that were received before the request was received.

3. The method of claim 1, wherein the context-dependent authentication policy associated with each of the plurality of secured states defines one or more acceptable authentication methods, the one or more acceptable authentication methods comprising one or more of:
facial recognition;
fingerprint;
voice matching;
a security pattern;
a personal identification code;
a password; and
a combination of two or more of these methods, where each of the two or more methods must be satisfied.

4. The method of claim 3, further comprising:
defining a hierarchy of security levels, where the context-dependent authentication policy for higher levels defines a subset of the authentication methods accepted for lower levels.

5. The method of claim 2, wherein the transition rules comprise a determination that:
an illumination sensor of the device indicates that the device has been positioned in a non-illuminated area for a time period that is within a threshold period of time.

6. The method of claim 2, wherein the transition rules comprise a determination that:
a positional sensor of the device sensor indicates that the device has been experienced a movement pattern or continuous non-movement for at least a threshold period of time.

7. The method of claim 2, wherein the transition rules comprise a determination that:
the location of the device has changed by entering or leaving a trusted location.

8. The method of claim 2, wherein the transition rules comprise a determination that:
an audio sensor of the device is capturing a recognized sound pattern.

9. The method of claim 2, wherein the transition rules comprise a determination that:
a temperature sensor of the device detects if the device environment has remained within a recognized temperature range for at least a threshold period of time.

10. The method of claim 2, wherein the transition rules comprise a determination that:
the device receives data indicating that the user has misplaced the device.

11. The method of claim 1, further comprising:
a transition rule that defines criteria for transitioning from an insecure security state to a re-authentication state;
in response to entering the re-authentication state, automatically causing the electronic device to perform an authentication process; and
transitioning the electronic device from the re-authentication state back to the insecure state only if a result of the authentication process satisfies an insecure state re-authentication policy.

12. The method of claim 1, further comprising:
receiving a request to access the electronic device;
determining that the device is in a secure state;
receiving an authentication attempt; and
determining whether the authentication attempt satisfies the context-dependent authentication policy.

13. A method of securing an electronic device, comprising:
determining, by a processor, that an electronic device is in a first secured state associated with a first security level;
based on the first security level, assigning a first context-dependent authentication policy to the electronic device;
determining that a transition rule has been satisfied; and
responsive to determining that the transition rule has been satisfied, causing the electronic device to transition into a second secured state, wherein the second secured state comprises a different security level than the first secured state; and
modifying the first context-dependent authentication policy to yield a second context-dependent authentication policy; and
changing the device from the second secured state upon the device receiving an authentication that satisfies the second context-dependent authentication policy.

14. The method of claim 13, wherein the transition rule comprises a determination that:
the device has remained in the first secured state for at least a timeout period; and one or more of the following:
an illumination sensor of the device indicates that the device has been positioned in a non-illuminated area for a time period that is within a window of time,
an audio sensor of the device is capturing a recognized sound pattern, and
a temperature sensor of the device detects that the device is has been located in an environment of a trusted temperature for at least a threshold period of time.

15. The method of claim 13, wherein the transition rule comprises a determination that:
the device has remained in the first secured state for at least a timeout period; and one or more of the following:
a positional sensor of the device sensor indicates that the device has been experienced a movement pattern or continuous non-movement for at least a threshold period of time, and
a location of the device corresponds to a trusted location.

16. The method of claim 13, wherein:
the first context-dependent authentication policy comprises facial recognition; and
the second context-dependent authentication policy comprises one or more of a passcode, an identification number, or a biometric identification.

17. An electronic device, comprising:
a processor;
a tangible memory containing security application programming instructions that instruct the processor to:
determine that an electronic device is in a first secured state associated with a first security level;
based on the first security level, assign a first context-dependent authentication policy to the electronic device;
determine that a transition rule has been satisfied; and
responsive to determining that the transition rule has been satisfied, cause the electronic device to transition into a second secured state, wherein the second secured state comprises a different security level than the first secured state; and
modify the first context-dependent authentication policy to yield a second context-dependent authentication policy; and
change the device from the second secured state upon the device receiving an authentication that satisfies the second context-dependent authentication policy.

18. The device of claim 17, wherein the security application programming instructions that instruct the processor to determine that a transition rule has been satisfied further comprise instructions that cause the processor to determine that:
the device has remained in the first secured state for at least a timeout period; and one or more of the following:
an illumination sensor of the device indicates that the device has been positioned in a non-illuminated area for a time period that is within a window of time,
an audio sensor of the device is capturing a recognized sound pattern, and
a temperature sensor of the device detects that the device is has been located in an environment of a trusted temperature for at least a threshold period of time.

19. The device of claim 17, wherein the security application programming instructions that instruct the processor to determine that a transition rule has been satisfied further comprise instructions that cause the processor to determine that:
the device has remained in the first secured state for at least a timeout period; and one or more of the following:
a positional sensor of the device sensor indicates that the device has been experienced a movement pattern or continuous non-movement for at least a threshold period of time, and
a location of the device corresponds to a trusted location.

20. The device of claim 17, further comprising an image sensor, wherein:
the first context-dependent authentication policy comprises using the image sensor to capture an image and causing the processor to apply facial recognition to the image; and
the second context-dependent authentication policy comprises one or more of a passcode, an identification number, or a biometric identification.
